(19) United States
(12) Patent Application Publication
(10) Pub. No.: US 2026/0087114 A1
(43) Pub. Date: Mar. 26, 2026

(54) INFORMATION PROCESSING APPARATUS, AUTHENTICATION METHOD, AND NON-TRANSITORY COMPUTER READABLE MEDIUM

(71) Applicant: NEC Corporation, Minato-ku, Tokyo (JP)

(72) Inventors: Yohei KOHNO, Tokyo (JP); Hiroyoshi SAWAI, Tokyo (JP)

(73) Assignee: NEC Corporation, Minato-ku, Tokyo (JP)

(21) Appl. No.: 19/107,157

(22) PCT Filed: Sep. 15, 2022
(86) PCT No.: PCT/JP2022/034524

§ 371 Date: Feb. 27, 2025

(51) Int. Cl. G06F 21/32; H04W 4/029

(52) U.S. Cl. CPC G06F 21/32; H04W 4/029

(57) ABSTRACT

A posture evaluation apparatus, a posture evaluation system, a posture evaluation method, and a non-transitory computer-readable medium that are able to evaluate a posture with high accuracy at a relatively low cost are provided. A posture evaluation apparatus includes a spine extracting means for extracting, based on an image acquired by imaging a side surface of a body of a subject person and position information about at least a cervical vertebrae, hip joints, and knee joints of the body on the image, a spine edge point cloud constituted of a predetermined number of points representing a spine shape on the image, a feature value calculating means for calculating a feature value about at least a spine, based on the position information and the spine edge point cloud, and a state estimating means for estimating a state of at least the spine, based on the feature value.

### TECHNICAL FIELD

The present disclosure relates to an information processing apparatus, an authentication system, an authentication method, and a non-transitory computer readable medium.

### BACKGROUND ART

Various attempts to improve the memories that visitors have of their visits to amusement facilities using face authentication techniques have been made. For example, Patent Literature 1 discloses an information processing apparatus that stores ticket information read at an entrance gate of an amusement facility and a face image of a visitor captured by a camera installed at an entrance in such a way that they are associated with each other. Patent Literature 1 further discloses that the information processing apparatus specifies a visitor by comparing a face image of a visitor captured by cameras installed in respective locations in the amusement facility with the stored face image mentioned above. Patent Literature 1 further discloses that the information processing apparatus grasps location information of a visitor based on information transmitted from a GPS transmitter mounted on an entrance ticket, thereby acquiring a moving path of the visitor. Patent Literature 1 further discloses providing, in a print providing space at an exit of the amusement facility, a printed matter of a visit record in which a movement path along which the visitor has moved is printed on a map of the amusement facility. Patent Literature 1 further discloses that images of characters or attractions in the amusement facility may be printed on the printed matter of the visit record.

### CITATION LIST

### Patent Literature

[Patent Literature 1] Japanese Unexamined Patent Application Publication No. 2022-096041

### SUMMARY OF INVENTION

### Technical Problem

However, in Patent Literature 1, a user, who is a visitor, cannot choose a character that he/she likes. As a result, it is possible that an image of a character that the user does not like may be printed as a visit record. It is therefore desired to improve the memories that the visitor has.

An object of the present disclosure is to provide an information processing apparatus, an authentication system, an authentication method, and a non-transitory computer readable medium capable of improving the memories that a visitor has.

### Solution to Problem

An information processing apparatus according to a first aspect of the present disclosure includes: preference information acquisition means for acquiring preference information regarding preference of a user; user information registration means for registering biometric information for registration of the user in association with the preference information of the user in storage means; authentication means for performing biometric authentication by comparing biometric information for authentication of the user acquired in each of a plurality of locations in a facility with the biometric information for registration; and guidance control means for controlling, in a case where the biometric authentication has been successful, a guidance based on at least the preference information of the user.

An authentication system according to a second aspect of the present disclosure includes: authentication terminals installed in a plurality of locations in a facility; and an information processing apparatus capable of communicating with the authentication terminals, in which the information processing apparatus includes: preference information acquisition means for acquiring preference information regarding preference of a user; and user information registration means for registering biometric information for registration of the user in association with the preference information of the user in storage means; the authentication terminal includes: authentication biometric information acquisition means for acquiring biometric information for authentication of the user, and the information processing apparatus further includes: authentication means for performing biometric authentication by comparing the biometric information for registration with the biometric information for authentication; and guidance control means for controlling, in a case where the biometric authentication has been successful, a guidance based on at least the preference information of the user.

In an authentication method according to a third aspect of the present disclosure, a computer: acquires preference information regarding preference of a user; registers biometric information for registration in association with the preference information of the user in storage means; performs biometric authentication by comparing biometric information for authentication of the user acquired in each of a plurality of locations in a facility with the biometric information for registration; and controls, in a case where the biometric authentication has been successful, a guidance based on at least the preference information of the user.

A non-transitory computer readable medium according to a fourth aspect of the present disclosure stores a program for causing a computer to execute: processing for acquiring preference information regarding preference of a user; processing for registering biometric information for registration in association with the preference information of the user in storage means; processing for performing biometric authentication by comparing biometric information for authentication of the user acquired in each of a plurality of locations in a facility with the biometric information for registration; and processing for controlling, in a case where the biometric authentication has been successful, a guidance based on at least the preference information of the user.

### Advantageous Effects of Invention

It is possible to provide an information processing apparatus, an authentication system, an authentication method, and a non-transitory computer readable medium capable of improving the memories that a visitor has.

### BRIEF DESCRIPTION of DRAWINGS

FIG. 1 is a block diagram showing one example of an information processing apparatus according to a first example embodiment;

FIG. 2 is a flowchart showing one example of an authentication method according to the first example embodiment;

FIG. 3 is a block diagram showing one example of an authentication system according to a second example embodiment;

FIG. 4 is a block diagram showing one example of an authentication terminal according to the second example embodiment;

FIG. 5 is a block diagram showing one example of an information processing apparatus according to the second example embodiment;

FIG. 6 is a diagram showing one example of a data structure of user information according to the second example embodiment;

FIG. 7 is a diagram showing one example of a data structure of history information according to the second example embodiment;

FIG. 8 is a diagram showing one example of a data structure of settlement history information according to the second example embodiment;

FIG. 9 is a diagram showing one example of a data structure of guidance information according to the second example embodiment;

FIG. 10 is a flowchart showing one example of processing for registering the user information in an authentication method according to the second example embodiment;

FIG. 11 is a flowchart showing one example of the authentication method according to the second example embodiment;

FIG. 12 is a diagram showing one example of a display unit of an authentication terminal according to the second example embodiment; and

FIG. 13 is a diagram showing another example of a display unit of the authentication terminal according to the second example embodiment.

### EXAMPLE EMBODIMENT

Hereinafter, with reference to the drawings, example embodiments of the present disclosure will be described.

### First Example Embodiment

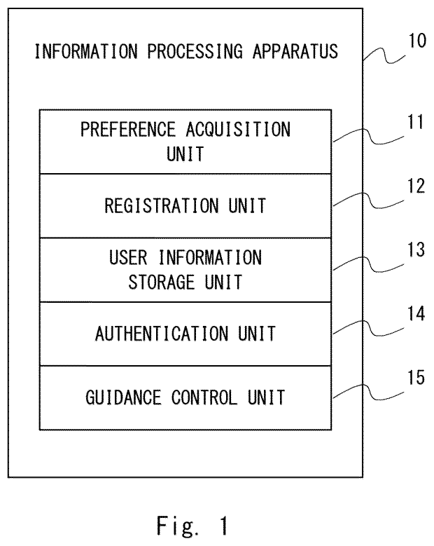

FIG. 1 is a block diagram showing one example of an information processing apparatus 10 according to a first example embodiment. The information processing apparatus 10 performs, for example, processing for biometric authentication of a user acquired in each of a plurality of locations of an amusement facility such as a theme park. The user here is a visitor visiting this amusement facility. The information processing apparatus 10 may communicate with authentication terminals (not shown) installed in the plurality of respective locations of the amusement facility. Further, the information processing apparatus 10 may communicate with a user terminal (not shown) that the user carries. Further, the information processing apparatus 10 may communicate with a registration terminal (not shown) installed inside or outside of the amusement facility.

As shown in FIG. 1, the information processing apparatus 10 includes a preference acquisition unit 11, a registration unit 12, a user information storage unit 13, an authentication unit 14, and a guidance control unit 15.

The preference acquisition unit 11 is also referred to as preference information acquisition means. The preference acquisition unit 11 acquires preference information regarding user's preference. The preference information here includes, for example, a name of a character (hereinafter it will be referred to as a “character name”) or a name of an attraction (hereinafter it will be referred to as an “attraction name”) in the amusement facility that the user likes.

Specifically, the preference information may be transmitted from one of the authentication terminals installed in the plurality of respective locations of the amusement facility to the information processing apparatus 10. Further, the preference information may be transmitted from the registration terminal (not shown) installed inside or outside of the amusement facility to the information processing apparatus 10. Further, the preference information may be transmitted from a user terminal (not shown) that can communicate with the information processing apparatus 10 to the information processing apparatus 10. The preference acquisition unit 11 supplies the transmitted preference information to the registration unit 12.

The registration unit 12 is also referred to as user information registration means. The registration unit 12 registers user information in the user information storage unit 13. The user information here is information in which at least user preference information and biometric information for registration of the user are associated with each other. The biometric information for registration of the user is, for example, information extracted from a body image generated by capturing an image of a user's body. The user's body whose image is to be captured is at least a part of the user's body, and is, for example, the face, a finger(s), an eye(s), an ear(s), or a palm(s) of the user. Note that the body image acquired by capturing the image of the user's body by one of the authentication terminals installed in the plurality of respective locations of the amusement facility may be transmitted from the authentication terminal to the information processing apparatus 10. Further, the information processing apparatus 10 may include a camera (not shown), and an image of the user's body may be captured by the camera, whereby the body image may be acquired. Further, the image of the user's body may be captured by a camera of the user terminal that can communicate with the information processing apparatus 10, and the body image may be input to the information processing apparatus 10 from the user terminal.

The user information storage unit 13 is also referred to as storage means. The user information storage unit 13 stores the biometric information for registration in association with the preference information.

The authentication unit 14 is also referred to as authentication means. The authentication unit 14 performs biometric authentication by comparing the biometric information for authentication of the user acquired by the authentication terminals installed in the plurality of respective locations of the amusement facility with the biometric information for registration stored in the user information storage unit 13.

The guidance control unit 15 is also referred to as guidance control means. The guidance control unit 15 controls, in a case where the biometric authentication has been successful, a guidance to be output in this authentication terminal based on the user preference information stored in the user information storage unit 13.

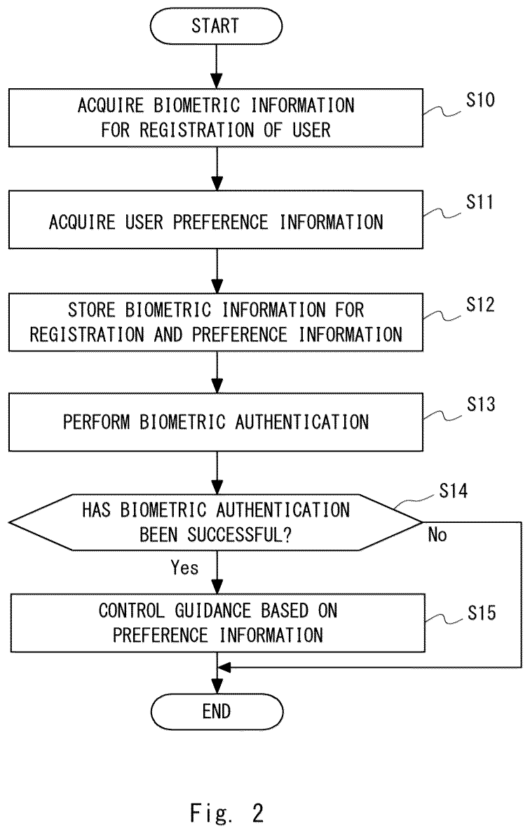

FIG. 2 is a flowchart showing an authentication method according to the first example embodiment. First, the registration unit 12 acquires the biometric information for registration of the user (Step S10). Next, the preference acquisition unit 11 acquires user preference information (Step S11). Next, the user information storage unit 13 stores the biometric information for registration of the user in association with the preference information of the user (Step S12). Next, the authentication unit 14 performs, in a case where the biometric information for authentication has been received from authentication terminals installed in a plurality of respective locations of an amusement facility, biometric authentication by comparing the biometric information for registration with the biometric information for authentication (Step S13). When the biometric authentication has not been successful (No in Step S14), this process is ended. On the other hand, in a case where the biometric authentication has been successful (Yes in Step S14), the guidance control unit 15 controls a guidance given by the authentication terminal based on the preference information stored in the user information storage unit 13 (Step S15), and this process is ended.

With the information processing apparatus 10 according to the first example embodiment described above, in each of authentication terminals installed in a plurality of respective locations of an amusement facility, a guidance which is based on the user preference information is given. It is therefore possible to improve the memories that the user has.

Note that the information processing apparatus 10 includes, as components that are not shown, a processor, a memory, and a storage apparatus. Further, this storage apparatus stores a computer program in which processing of an authentication method according to this example embodiment is implemented. Then the processor loads a computer program into the memory from the storage apparatus to execute this computer program. Accordingly, the processor implements functions of the preference acquisition unit 11, the registration unit 12, the authentication unit 14, and the guidance control unit 15.

Alternatively, each of the preference acquisition unit 11, the registration unit 12, the authentication unit 14, the guidance control unit 15 may be implemented by special-purpose hardware. Further, some or all of the components of each apparatus may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as the processor.

### Second Example Embodiment

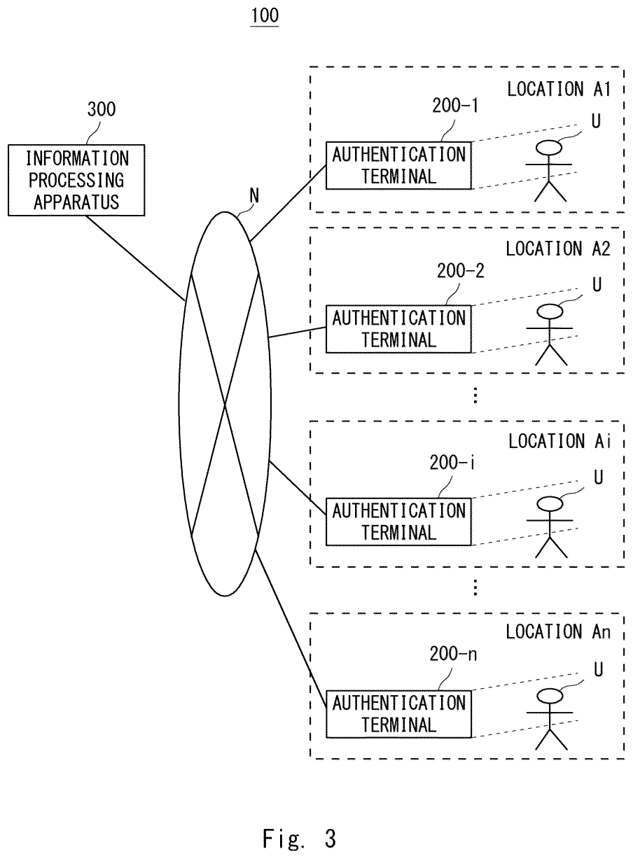

Next, an authentication system 100 according to a second example embodiment will be described. FIG. 3 is a block diagram showing an overall structure of the authentication system 100 according to the second example embodiment. The authentication system 100 is a computer system that performs biometric authentication of a user U in an amusement facility such as a theme park. Hereinafter, face authentication will be taken as an example of biometric authentication, but this is merely an example.

The authentication system 100 includes authentication terminals 200-1, 200-2, . . . 200-i, . . . 200-n (1≤i≤n, n is a positive integer) and an information processing apparatus 300. The authentication terminals 200-1, 200-2, . . . 200-i, . . . and 200-n and the information processing apparatus 300 may communicate with each other via a network N. Note that the information processing apparatus 300 may communicate with user terminals (not shown) carried by users. The information processing apparatus 300 may communicate with a registration terminal (not shown) installed inside or outside of the amusement facility. Further, the authentication terminals 200-1, 200-2, . . . 200-i, . . . and 200-n may communicate with the user terminals by a predetermined mode of short-range radio communication. Further, the authentication terminals 200-1, 200-2, . . . 200-i, . . . and 200-n may communicate with the user terminals via the network N. Further, the network N is a wired or wireless communication line.

In the following description, each of the authentication terminals 200-1, 200-2, . . . 200-i, . . . and 200-n may be simply referred to as an authentication terminal(s) 200 when it is not necessary to distinguish between them. The authentication terminals 200 are, for example, digital signage installed in a plurality of respective locations of the amusement facility, i.e., a location 1, a location 2, . . . a location i, . . . and a location n.

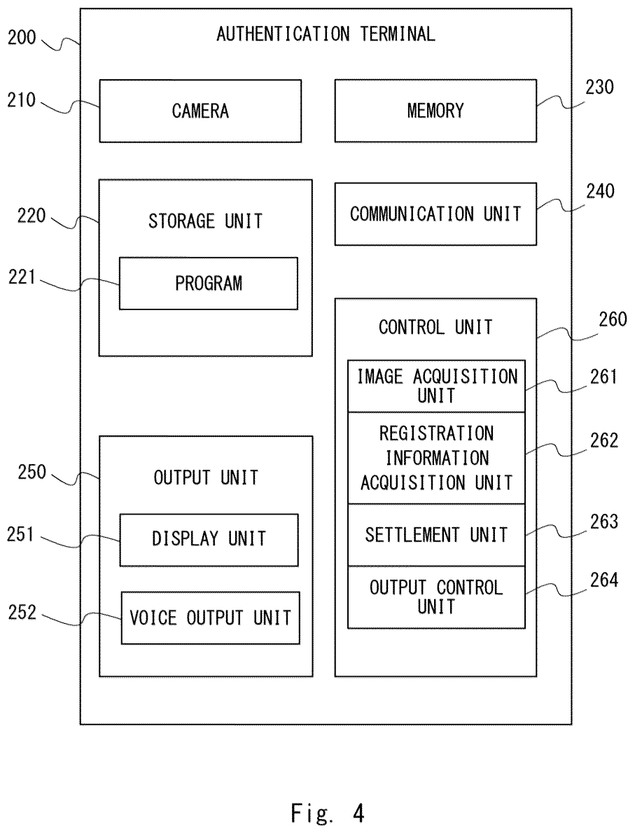

FIG. 4 is a block diagram showing one example of the authentication terminal 200. As shown in FIG. 4, the authentication terminal 200 includes a camera 210, a storage unit 220, a memory 230, a communication unit 240, an output unit 250, and a control unit 260.

The camera 210 captures images in accordance with control of the control unit 260. The camera 210 captures an image of a face of a user U in accordance with control of the control unit 260.

The storage unit 220 is a storage apparatus that stores a program 221 for implementing each function of the authentication terminal 200. The memory 230, which is a volatile storage apparatus such as a RAM, is a storage area for temporarily holding information when the control unit 260 is operated. The communication unit 240 is a communication interface with the network N.

The output unit 250 outputs results of information processing in the control unit 260. The output unit 250 includes, for example, a display unit 251 and a voice output unit 252. The display unit 251 is a display apparatus that displays the results of information processing in the control unit 260. Note that the authentication terminal 200 may include an input unit (not shown) that receives input, and the display unit 251 and the input unit may be integrally configured like, for example, a touch panel. The voice output unit 252, which includes a speaker (not shown), outputs the results of information processing in the control unit 260 by voice.

The control unit 260 is a processor that controls each component of the authentication terminal 200, that is, a control apparatus. The control unit 260 causes the program 221 to be loaded to the memory 230 from the storage unit 220 to execute the loaded program 221. Accordingly, the control unit 260 implements the functions of an image acquisition unit 261, a registration information acquisition unit 262, a settlement unit 263, and an output control unit 264.

The image acquisition unit 261 is also referred to as authentication biometric information acquisition means. The image acquisition unit 261 controls the camera 210 to cause the camera 210 to capture an image of the face of the user U and generate a face image for authentication including at least a face area of the user U. Then, the image acquisition unit 261 acquires the face image for authentication and the date and time of image capturing from the camera 210.

The image acquisition unit 261 supplies the face image for authentication and the date and time of image capturing to the communication unit 240, and causes the communication unit 240 to transmit the face image for authentication and the date and time of image capturing to the information processing apparatus 300 along with location information of the authentication terminal 200 (a location 1, a location 2, . . . a location i, . . . and a location n).

Further, the image acquisition unit 261 controls the camera 210 to cause the camera 210 to capture an image of the face of the user U and generate a face image for registration including at least the face area of the user U. Then, the image acquisition unit 261 may supply the face image for registration to the communication unit 240 and cause the communication unit 240 to transmit the face image for registration to the information processing apparatus 300.

Note that the face image for registration may be captured by a user terminal (not shown) and transmitted from the user terminal to the information processing apparatus 300. Further, the face image for registration may be captured in the registration terminal installed inside or outside of the amusement facility and transmitted from the registration terminal to the information processing apparatus 300.

The registration information acquisition unit 262 acquires registration information of the user U. The registration information of the user U here includes the name, the address, and the telephone number of the user U, information required to carry out settlement, settlement information, benefit information, etc. Further, the information required to carry out settlement is the number of a card used for settlement, the expiration date thereof, or the like. Further, the settlement information includes, for example, the name of the product or service that the user U has purchased, the price of the product or the service, or the date and time of the purchase. Further, the name of the product that the user U has purchased is, for example, the name of food or drink that the user U has had in the amusement facility. Further, the name of the service that the user U has purchased is, for example, the name of an attraction that the user U has experienced in the amusement facility. Further, the benefit information is earned points, coupons, etc.

The registration information may be input to the authentication terminal 200 by the user U operating an input unit (not shown) of the authentication terminal 200. The registration information acquisition unit 262 may include a card reader, and acquire, for example, registration information of the user U by reading a license or a credit card. Then, the registration information acquisition unit 262 supplies the registration information of the user U to the communication unit 240 to cause the communication unit 240 to transmit the registration information to the information processing apparatus 300.

Note that the registration information may be transmitted from a user terminal (not shown) to the information processing apparatus 300. Further, the registration information may be transmitted from the registration terminal installed inside or outside of the amusement facility to the information processing apparatus 300.

The settlement unit 263 carries out settlement in a case where the biometric authentication for carrying out settlement in the authentication terminal 200 has been successful. Specifically, the settlement unit 263 acquires information required to carry out settlement by the user U who has been successful in the biometric authentication from the information processing apparatus 300 and carries out settlement. The settlement unit 263 acquires information required to carry out settlement from the registration information 312C associated with a user ID 312A received from the information processing apparatus 300 along with the face authentication result. Further, after the settlement is completed, the settlement unit 263 supplies settlement information of the user U to the communication unit 240 and causes the communication unit 240 to transmit the settlement information to the information processing apparatus 300.

The output control unit 264 controls the output unit 250, causes the output unit 250 to output an information processing result to broadcast the information processing result to the user U.

For example, in a case where the output control unit 264 has received a guidance instruction (described later) from the information processing apparatus 300, the output control unit 264 causes the output unit 250 to output a guidance, and present the guidance to the user U. The guidance here is a guidance which is based on at least preference information of the user U. The preference information is, for example, a character name or an attraction name of the amusement facility that the user U prefers.

Further, the output control unit 264 causes the output unit 250 to output the result of the face authentication to broadcast the result of the face authentication to the user U.

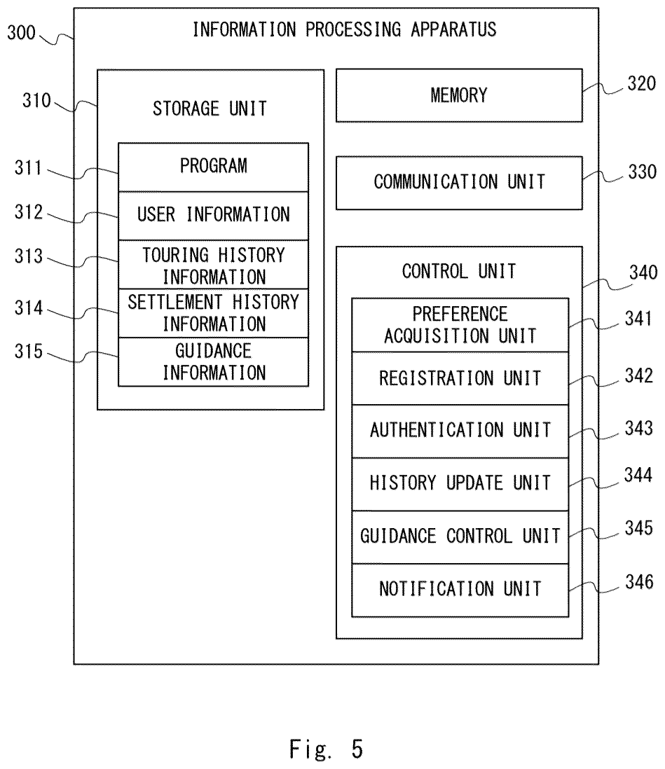

FIG. 5 is a block diagram showing one example of the information processing apparatus 300. As shown in FIG. 5, the information processing apparatus 300 includes a storage unit 310, a memory 320, a communication unit 330, and a control unit 340.

The storage unit 310 is a storage apparatus that stores a program 311 for implementing each function of the information processing apparatus 300. The memory 320, which is a volatile storage apparatus such as a RAM, is a storage area for temporarily holding information at the time of operation of the control unit 340. The communication unit 330 is a communication interface with the network N.

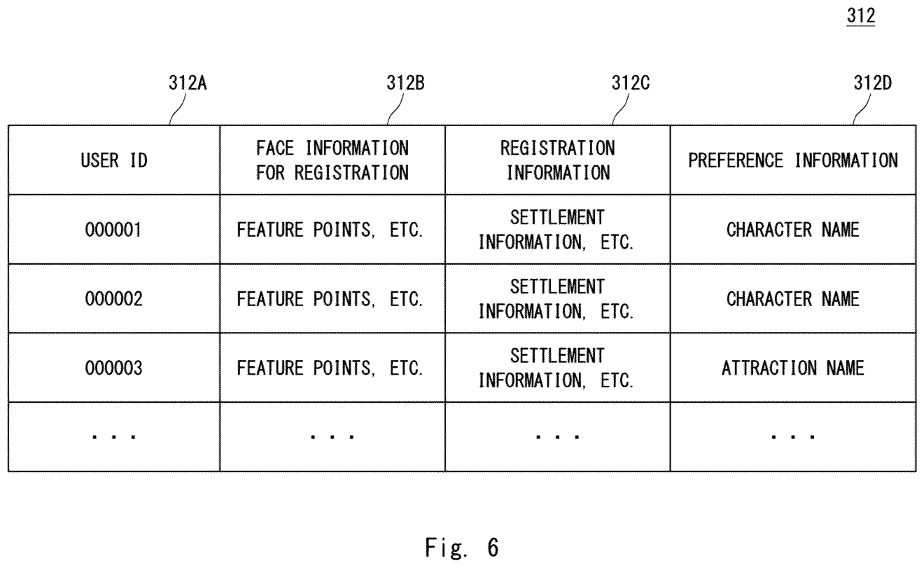

The storage unit 310 stores user information 312. Therefore, the storage unit 310 is also referred to as user information storage means. FIG. 6 shows one example of the user information 312. As shown in FIG. 6, the user information 312 is information in which a user ID 312A, face information for registration 312B, which is biometric information for registration, registration information 312C, and preference information 312D are associated with one another. Note that the user information 312 may include management information such as the date and time of image capturing of the face image for registration.

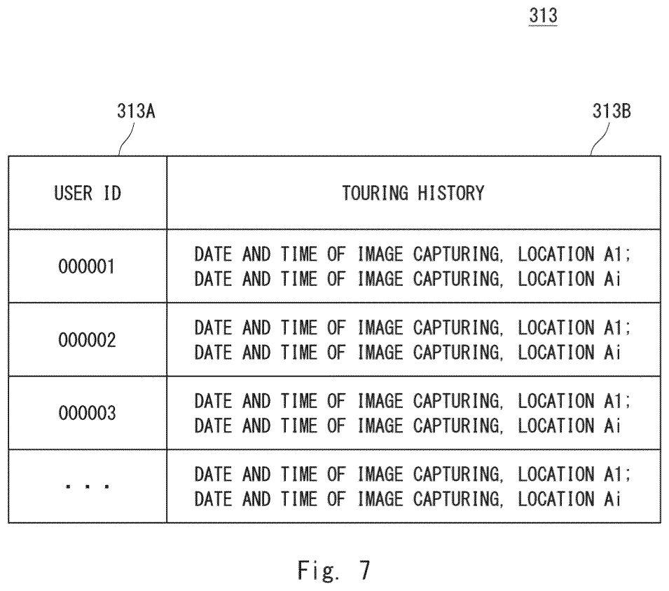

The storage unit 310 stores touring history information 313. FIG. 7 shows one example of the touring history information 313. As shown in FIG. 7, the touring history information 313 is information in which a user ID 313A and touring history 313B are associated with each other. The touring history 313B is touring history of the user U in the amusement facility. Specifically, the touring history 313B is the date and time when the face image for authentication of the user U has been captured, and location information of the authentication terminal 200, both of the information items being received from the authentication terminal 200.

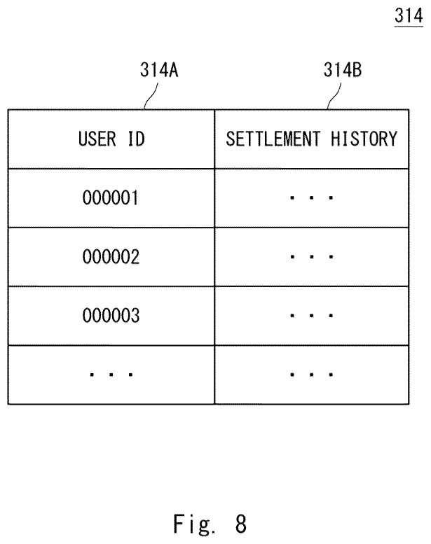

The storage unit 310 stores settlement history information 314. FIG. 8 shows one example of the settlement history information 314. As shown in FIG. 8, the settlement history information 314 is information in which a user ID 314A and a settlement history 314B are associated with each other. The settlement history 314B is the history of the settlement information of the user U.

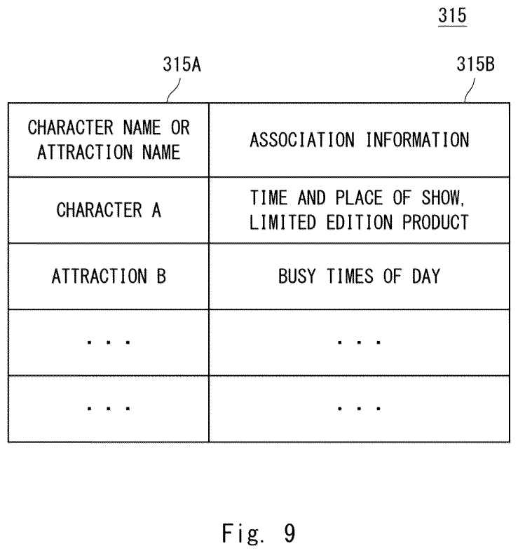

The storage unit 310 stores guidance information 315. FIG. 9 shows one example of the guidance information 315. As shown in FIG. 9, the guidance information 315 is information in which a character name or an attraction name 315A and association information 315B are associated with each other. The association information 315B is, for example, the time and place of a show in which the character with the character name 315A will appear, the name of a limited edition product related to this character and the place where it is sold, and busy times of day when many visitors will be visiting the attraction with the attraction name 315A.

The control unit 340 is a processor that controls each component of the information processing apparatus 300, that is, a control apparatus. The control unit 340 causes the program 311 to be loaded into the memory 320 from the storage unit 310, thereby executing the program 311. Accordingly, the control unit 340 implements the functions of a preference acquisition unit 341, a registration unit 342, an authentication unit 343, a history update unit 344, a guidance control unit 345, and a notification unit 346.

The preference acquisition unit 341 is also referred to as preference information acquisition means. The preference acquisition unit 341 acquires preference information regarding user's preference. Specifically, the preference information may be transmitted from one of the authentication terminals 200 installed in the plurality of respective locations 1, 2, . . . i, . . . and n in the amusement facility to the information processing apparatus 300. Further, the preference information may be transmitted from the registration terminal (not shown) installed inside or outside of the amusement facility to the information processing apparatus 300. Further, the preference information may be transmitted from a user terminal (not shown) capable of communicating with the information processing apparatus 300 to the information processing apparatus 300. The preference acquisition unit 341 supplies the transmitted preference information to the registration unit 342.

The registration unit 342 is also referred to as user information registration means. The registration unit 342 registers the user information 312 in the storage unit 310. The registration unit 342 acquires, in a case where it has received the face image for registration and the registration information from any one of the authentication terminal 200, a user terminal (not shown), or a registration terminal (not shown), the face information for registration 312B from the face image for registration. Next, the registration unit 342 stores the user ID 312A, the face information for registration 312B, the registration information 312C, and the preference information 312D supplied from the preference acquisition unit 341 in the storage unit 310 as the user information 312 in such a way that they are associated with one another. As one example, the face information may be a set of feature points extracted from the face image. Specifically, the registration unit 342 detects a face area included in the face image for registration, extracts feature points from the detected face area, and sets the information on the extracted feature points as face information for registration 312B.

Further, the registration unit 342 generates a user ID 312A. Note that the user ID 312A may be input to the authentication terminal 200, a user terminal (not shown), and a registration terminal (not shown) by the user U operating an input unit (not shown) of any one of the authentication terminal 200, the user terminal (not shown), or the registration terminal (not shown). Then the user ID 312A may be transmitted to the information processing apparatus 300 from any one of the authentication terminal 200, the user terminal (not shown), or the registration terminal (not shown) along with the face image for registration and the registration information. Further, a password, along with the user ID 312A, may be transmitted to the information processing apparatus 300 from any one of the authentication terminal 200, the user terminal (not shown), or the registration terminal (not shown). In other words, the registration unit 342 may store the user ID 312A, the password, the face information for registration 312B, the registration information 312C, and the preference information 312D in the storage unit 310 as the user information 312 in such a way that they are associated with one another. Further, in a case where management information such as the date and time of image capturing of the face image for registration has been transmitted from any one of the authentication terminal 200, the user terminal (not shown), or the registration terminal (not shown), the registration unit 342 may store the user ID 312A, the face information for registration 312B, the registration information 312C, the preference information 312D, and the management information in the storage unit 310 as the user information 312 in such a way that they are associated with one another.

The authentication unit 343 is also referred to as authentication means. The authentication unit 343 performs face authentication (biometric authentication) in a case where it has received a face image for authentication from the authentication terminal 200. Then, the authentication unit 343 acquires face information for authentication from the face image for authentication transmitted from the authentication terminal 200, and compares the face information for registration 312B with the face information for authentication, to thereby perform face authentication. Since a method for acquiring the face information for authentication from the face image for authentication is similar to the method for acquiring the face information for registration 312B from the face image for registration in the registration unit 342, the descriptions thereof will be omitted. Further, in a case where the face information for authentication matches the face information for registration 312B, the authentication unit 343 acquires a user ID 312A and preference information 312D associated with the face information for registration 312B by referring to the user information 312. The authentication unit 343 then supplies information indicating whether or not the face information items match each other, the user ID 312A, and the preference information 312D to the guidance control unit 345. Further, in a case where the face information for authentication matches the face information for registration 312B, the authentication unit 343 acquires a user ID 312A associated with the face information for registration 312B by referring to the user information 312. The authentication unit 343 then supplies information indicating whether or not the face information items match each other and the user ID 312A to the notification unit 346. The information indicating whether or not the face information items match each other corresponds to information indicating whether or not the authentication has been successful. Note that the face information items matching each other (match: yes) means that the degree of match being equal to or greater than a predetermined value.

The history update unit 344 is also referred to as history update means.

The history update unit 344 updates, in a case where the biometric authentication has been successful, the touring history information 313 of the user U who has successfully passed the biometric authentication. Specifically, the history update unit 344 adds the date and time of image capturing of the face image for authentication and location information (location 1, location 2, . . . location i, . . . location n) of the authentication terminal 200, the information items being received from the authentication terminal 200 along with the face image for authentication, to the touring history 313B of the touring history information 313.

Further, the history update unit 344 updates, in a case where the biometric authentication has been successful and settlement has been carried out in the authentication terminal 200, the settlement history information 314 of the user U who has successfully passed the biometric authentication based on the settlement information received from the authentication terminal 200. Specifically, the name of the product or the service that the user U has purchased, the price of the product or the service, and the date and time of the purchase, the information items being included in the settlement information, are added to the settlement history 314B of the settlement history information 314.

The guidance control unit 345 is also referred to as guidance control means. The guidance control unit 345 controls, in a case where the biometric authentication has been successful, a guidance in the authentication terminal 200 based on at least the preference information 312D of the user U supplied from the authentication unit 343. Specifically, the guidance control unit 345 acquires, from the guidance information 315, association information 315B associated with the character name 315A or the attraction name 315A, which is the preference information 312D. Then, the guidance control unit 345 determines the content of the guidance to be output by the output unit 250 of the authentication terminal 200 as the content including at least a part of the association information 315B.

Further, when the biometric authentication has been successful, the guidance control unit 345 may control a guidance in the authentication terminal 200 based on the preference information 312D, the touring history 313B, and the settlement history 314B of the user U. Specifically, the guidance control unit 345 acquires, from the touring history information 313, a touring history 313B associated with the user ID 313A that matches the user ID 312A of the user U supplied from the authentication unit 343. Further, the guidance control unit 345 acquires, from the settlement history information 314, settlement history 314B associated with the user ID 314A that matches the user ID 312A of the user U supplied from the authentication unit 343. Then, the guidance control unit 345 controls the guidance in the authentication terminal 200 based on the preference information 312D, the touring history 313B, and the settlement history 314B of the user U who has successfully passed the biometric authentication. Specifically, the guidance control unit 345 acquires, from the association information 315B, information suitable for the guidance based on the touring history 313B and the settlement history 314B. For example, the guidance control unit 345 determines whether or not the number of times the user U has been to the attraction is equal to or greater than a predetermined number of times and whether or not purchased products include a predetermined product name based on the touring history 313B and the settlement history 314B. Then, the guidance control unit 345 acquires information suitable for the guidance from the association information 315B based on the results of the determination. Then, the guidance control unit 345 determines the content of the guidance to be output by the output unit 250 of the authentication terminal 200 as the content including this suitable information.

In a case where the face authentication result indicates face information match: yes, that is, face authentication has been successful, the notification unit 346 notifies the authentication terminal 200 of the face authentication result and the user ID 312A. Note that the user ID 312A may be included in the face authentication result.

Further, the notification unit 346 may transmit information indicating that the face authentication has failed to the authentication terminal 200 as an error notification. Note that the notification unit 346 may cause the user ID 312A to be included in the error notification. However, this is merely an example.

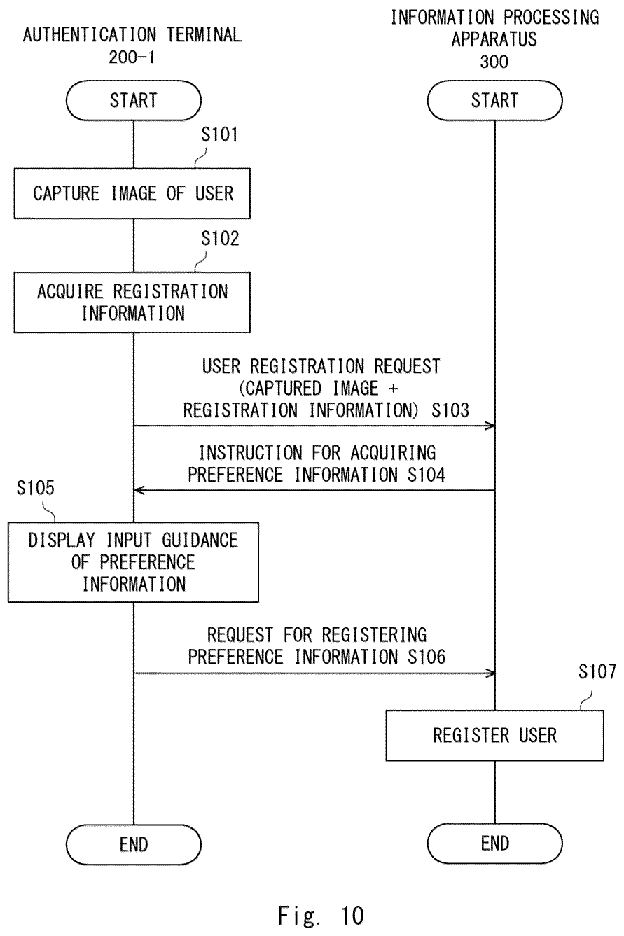

FIG. 10 is a flowchart showing one example of processing for registering user information in the authentication method according to the second example embodiment. In the following flowchart, an explanation will be given of a case where a face image for registration of the user U and registration information are acquired in the authentication terminal 200-1 installed in the first location A1, among authentication terminals 200-1, 200-2, . . . 200-i, . . . and 200-n installed in a plurality of respective locations A1, A2, Ai, . . . and An of an amusement facility, as an example. The first location A1 here is, for example, a location of the authentication terminal 200-1 installed at or near a gate of the amusement facility. However, the face image for registration of the user U and the registration information may be acquired in a user terminal (not shown) of the user U or a registration terminal installed inside or outside of the amusement facility and transmitted to the information processing apparatus 300.

First, the image acquisition unit 261 of the authentication terminal 200-1 causes the camera 210 to capture an image of the face of the user U to acquire the face image for registration (Step S101). Next, the registration information acquisition unit 262 of the authentication terminal 200-1 acquires registration information on the user U (Step S102). Next, the communication unit 240 transmits the face image for registration and the registration information to the information processing apparatus 300 and requests user registration (Step S103). Next, the preference acquisition unit 341 of the information processing apparatus 300 causes the communication unit 330 to transmit an instruction for acquiring preference information to the authentication terminal 200 (Step S104). Next, the output unit 250 of the authentication terminal 200-1 displays an input guidance of the preference information (Step S105). Next, the communication unit 240 of the authentication terminal 200-1 transmits a request for registering preference information to the information processing apparatus 300 (Step S106). Next, the registration unit 342 of the information processing apparatus 300 registers the user (Step S107), and this process is ended. Specifically, the registration unit 342 generates face information for registration 312B from the face image for registration. Further, the registration unit 342 further generates a user ID 312A. Then, the registration unit 342 stores the user ID 312A, the face information for registration 312B, the registration information 312C, and the preference information 312D in the storage unit 310 as the user information 312 in such a way that they are associated with one another.

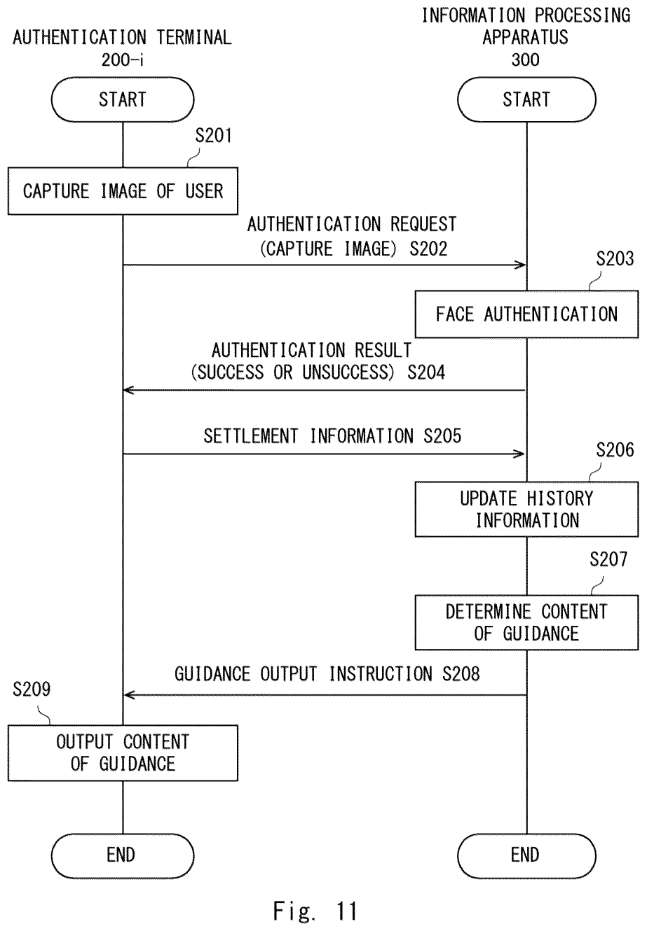

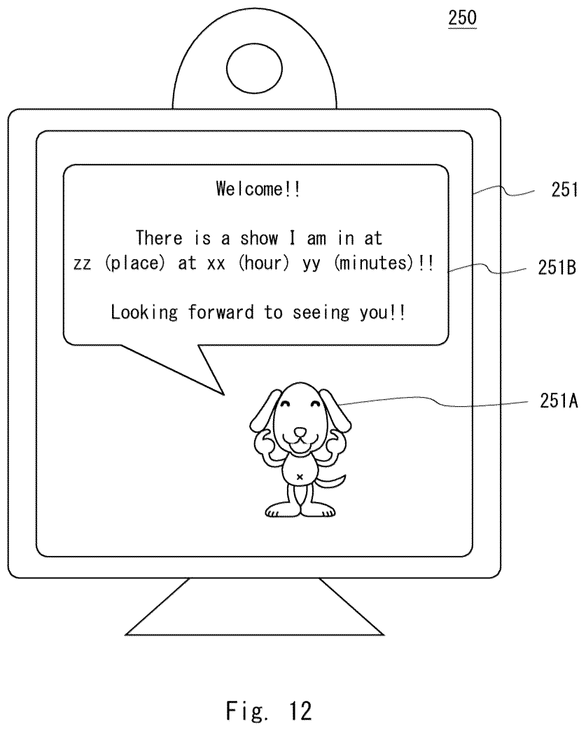

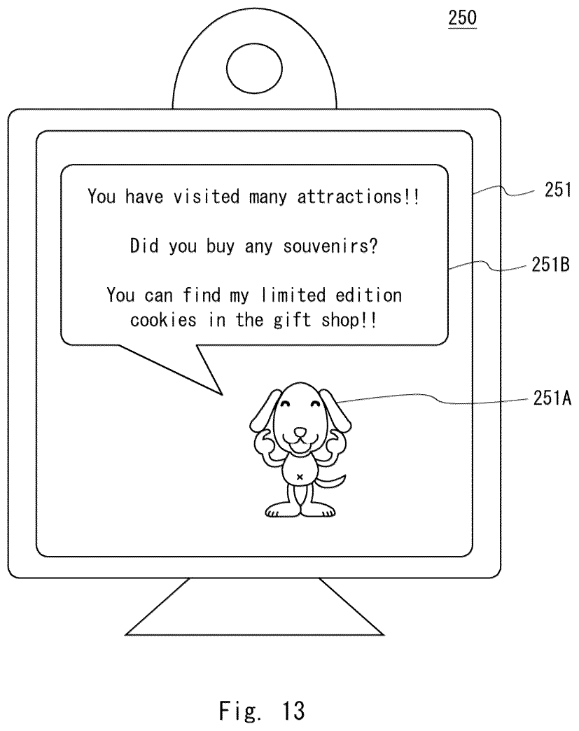

FIG. 11 is a flowchart showing an authentication method according to the second example embodiment. The authentication method shown in FIG. 11 is performed after the processing for registering user information shown in FIG. 10 is performed. Further, in a case where the settlement processing is not performed in the authentication terminal 200-i in the flowchart shown in FIG. 11, the processing of Step S205 is omitted. First, the image acquisition unit 261 of the authentication terminal 200-i causes the camera 210 to capture the face of the user U to acquire the face image for authentication (Step S201). Next, the communication unit 240 transmits the face image for authentication, the date and time of image capturing, and the location information to the information processing apparatus 300, and requests authentication (Step S202). Next, the authentication unit 343 of the information processing apparatus 300 performs face authentication (Step S203). Specifically, the authentication unit 343 generates face information for authentication from the face image for authentication, compares this face information for authentication with face information for registration 312B of the user information 312, and determines, when the degree of match of these face information items is equal to or greater than a predetermined value, that the face authentication has been successful. Next, the notification unit 346 notifies the authentication terminal 200-i of the authentication result indicating whether or not the face authentication has been successful and the user ID 312A (Step S204). Next, in a case where the face authentication has been successful, the settlement unit 263 of the authentication terminal 200-i carries out the settlement, and the communication unit 240 transmits the settlement information to the information processing apparatus 300 (Step S205). Between Steps S204 and S205, the output control unit 264 of the authentication terminal 200-i may cause the output unit 250 to display or output, by voice, a result of the face authentication to broadcast the result of the face authentication to the user U. Next, in a case where the face authentication has been successful, the history update unit 344 of the information processing apparatus 300 updates the touring history information 313 and the settlement history information 314 of the storage unit 310 (Step S206). Specifically, the history update unit 344 updates the touring history information 313 based on the date and time of image capturing and the location information received in Step S202. Further, the history update unit 344 updates the settlement history information 314 based on the settlement information received in Step S205. Next, the guidance control unit 345 of the information processing apparatus 300 determines the content of the guidance performed in the authentication terminal 200-i based on the preference information 312D, the touring history 313B, and the settlement history 314B of the user U (Step S207). For example, the guidance control unit 345 determines, in a case where biometric authentication has been successful in the first location A1 among the plurality of locations A1, A2, . . . Ai, . . . and An, the content of the guidance based on the preference information 312D of the user U. At or before the first location A1, in general, settlement has not yet been carried out and a touring history has not yet been registered. Therefore, the guidance control unit 345 determines the content of the guidance based on the preference information 312D of the user U. For example, the guidance control unit 345 determines, in a case where the preference information 312D of the user U is the name of the character that the user U likes, the content to be displayed on the display unit 251 of the authentication terminal 200 to be an image 251A of this character and a message 251B from this character, as shown in FIG. 12. Further, the guidance control unit 345 determines that the content of the message 251B is a greeting “Welcome!!” and a schedule regarding this character “There is a show I am in at zz (place) at xx (hour) yy (minutes)!! Looking forward to seeing you!!”, as shown in FIG. 12. Further, in a case where the biometric authentication has been successful in the location Ai which, among the plurality of locations A1, A2, . . . , Ai, . . . and An, is other than the first location A1, the guidance control unit 345 determines the content of the guidance based on the preference information 312D, the touring history 313B, and the settlement history 314B of the user U. For example, in a case where the preference information 312D of the user U is the name of the character that the user U likes, the guidance control unit 345 determines the content to be displayed on the display unit 251 of the authentication terminal 200-i to be an image 251A of this character and a message 251B from this character, as shown in FIG. 13. Further, the guidance control unit 345 determines, for example, based on the touring history 313B and the settlement history 314B, whether the number of times the user U has been to the attraction is equal to or greater than a predetermined number of times and whether the names of the purchased products include souvenirs. In a case, for example, where the number of times the user U has been to the attraction is equal to or greater than a predetermined number of times and the names of the purchased products do not include souvenirs, the guidance control unit 345 determines that the content of the message 251B to be “You have visited many attractions!!”, “Did you buy any souvenirs?” and information on souvenirs regarding this character “You can find my limited edition cookies in the gift shop!!”, as shown in FIG. 13. Next, the communication unit 330 transmits a guidance control instruction to the authentication terminal 200-i (Step S208). Next, the output control unit 264 of the authentication terminal 200-i causes the output unit 250 to output the guidance as shown in FIG. 12 or 13 (Step S209), and this process is ended.

With the authentication system 100 according to the second example embodiment described above, a guidance which is based on the preference information 312D of the user U is given in the authentication terminals 200-1, 200-2, . . . 200-i, . . . and 200-n respectively installed in the locations A1, A2, . . . , Ai, . . . and An of the amusement facility. It is therefore possible to improve the memories that the user U has.

Further, in the authentication system 100 according to the second example embodiment, in a case where the biometric authentication has been successful in the first location A1 among the plurality of locations A1, A2, . . . Ai, . . . and An, the content of the guidance is determined based on the preference information 312D of the user U. Further, in a case where the biometric authentication has been successful in the location Ai which, among the plurality of locations A1, A2, . . . , Ai, . . . and An, is other than the first location A1, the content of the guidance is determined based on the preference information 312D, the touring history 313B, and the settlement history 314B of the user U. Therefore, different guidance may be given for each location where biometric authentication is performed.

In the aforementioned example embodiments, the present disclosure has been described as a hardware configuration. However, this is merely an example. The present disclosure may implement desired processing by causing a processor to execute a computer program.

In the above-described examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (e.g., mask ROM, PROM (Programmable ROM), EPROM (Erasable PROM), flash ROM, and RAM (Random Access Memory), etc.) The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present application has been described above with reference to the example embodiments, the present application is not limited to the above-described example embodiments. Various changes that can be understood by those skilled in the art within the scope of the present application can be made to the configurations and the details of the present application.

The whole or part of the example embodiments disclosed above can be described as, but not limited to, the following supplementary notes.

### (Supplementary Note 1)

An information processing apparatus comprising:
preference information acquisition means for acquiring preference information regarding preference of a user;
user information registration means for registering biometric information for registration of the user in association with the preference information of the user in storage means;
authentication means for performing biometric authentication by comparing biometric information for authentication of the user acquired in each of a plurality of locations in a facility with the biometric information for registration; and
guidance control means for controlling, in a case where the biometric authentication has been successful, a guidance based on at least the preference information of the user.

### (Supplementary Note 2)

The information processing apparatus according to Supplementary Note 1, wherein the guidance control means controls, in a case where the biometric authentication has been successful in the first location among the plurality of locations, the guidance based on the preference information of the user.

### (Supplementary Note 3)

The information processing apparatus according to Supplementary Note 2, further comprising history update means for acquiring touring history information regarding a touring history of the user in the facility,
wherein the guidance control means controls, in a case where the biometric authentication has been successful in one of the plurality of locations other than the first location, the guidance based on the preference information and the touring history information of the user.

### (Supplementary Note 4)

The information processing apparatus according to Supplementary Note 2, further comprising history update means for acquiring settlement history information regarding a settlement history of the user in the facility, wherein the guidance control means controls, in a case where the biometric authentication has been successful in one of the plurality of locations other than the first location, the guidance based on the preference information and the settlement history information of the user.

### (Supplementary Note 5)

An authentication system comprising:
authentication terminals installed in a plurality of locations in a facility; and
an information processing apparatus capable of communicating with the authentication terminals, wherein
the information processing apparatus comprises:
   preference information acquisition means for acquiring preference information regarding preference of a user; and
   user information registration means for registering biometric information for registration of the user in association with the preference information of the user in storage means;
the authentication terminal comprises:
   authentication biometric information acquisition means for acquiring biometric information for authentication of the user, and
the information processing apparatus further comprises:
   authentication means for performing biometric authentication by comparing the biometric information for registration with the biometric information for authentication; and
   guidance control means for controlling, in a case where the biometric authentication has been successful, a guidance based on at least the preference information of the user.

### (Supplementary Note 6)

The authentication system according to Supplementary Note 5, wherein the guidance control means controls, in a case where the biometric authentication has been successful in the first location among the plurality of locations, the guidance based on the preference information of the user.

### (Supplementary Note 7)

The authentication system according to Supplementary Note 6, wherein
the information processing apparatus further comprises history update means for acquiring touring history information regarding a touring history of the user in the facility, and
the guidance control means controls, in a case where the biometric authentication has been successful in one of the plurality of locations other than the first location, the guidance based on the preference information and the touring history information of the user.

### (Supplementary Note 8)

The authentication system according to Supplementary Note 6, wherein
the information processing apparatus further comprises history update means for acquiring settlement history information regarding a settlement history of the user in the facility, and
the guidance control means controls, in a case where the biometric authentication has been successful in one of the plurality of locations other than the first location, the guidance based on the preference information and the settlement history information of the user.

### (Supplementary Note 9)

An authentication method, wherein a computer:
acquires preference information regarding preference of a user;
registers biometric information for registration in association with the preference information of the user in storage means;
performs biometric authentication by comparing biometric information for authentication of the user acquired in each of a plurality of locations in a facility with the biometric information for registration; and
controls, in a case where the biometric authentication has been successful, a guidance based on at least the preference information of the user.

### (Supplementary Note 10)

The authentication method according to Supplementary Note 9, wherein the computer controls, in a case where the biometric authentication has been successful in the first location among the plurality of locations, the guidance based on the preference information of the user.

### Supplementary Note 11

The authentication method according to Supplementary Note 10, wherein the computer:
further acquires touring history information regarding a touring history of the user in the facility; and
controls, in a case where the biometric authentication has been successful in one of the plurality of locations other than the first location, the guidance based on the preference information and the touring history information of the user.

### (Supplementary Note 12)

The authentication method according to Supplementary Note 10, wherein the computer:
further acquires settlement history information regarding a settlement history of the user in the facility; and
controls, in a case where the biometric authentication has been successful in one of the plurality of locations other than the first location, the guidance based on the preference information and the settlement history information of the user.

### (Supplementary Note 13)

A non-transitory computer readable medium storing a program for causing a computer to execute:
processing for acquiring preference information regarding preference of a user;
processing for registering biometric information for registration in association with the preference information of the user in storage means;
processing for performing biometric authentication by comparing biometric information for authentication of the user acquired in each of a plurality of locations in a facility with the biometric information for registration; and
processing for controlling, in a case where the biometric authentication has been successful, a guidance based on at least the preference information of the user.

### (Supplementary Note 14)

The non-transitory computer readable medium according to Supplementary Note 13, the non-transitory computer readable medium storing a program for causing the computer to execute processing for controlling, in a case where the biometric authentication has been successful in the first location among the plurality of locations, the guidance based on the preference information of the user.

### (Supplementary Note 15)

The non-transitory computer readable medium according to Supplementary Note 14, the non-transitory computer readable medium storing a program for causing the computer to execute:
processing for further acquiring touring history information regarding a touring history of the user in the facility; and
processing for controlling, in a case where the biometric authentication has been successful in one of the plurality of locations other than the first location, the guidance based on the preference information and the touring history information of the user.

### (Supplementary Note 16)

The non-transitory computer readable medium according to Supplementary Note 14, the non-transitory computer readable medium storing a program for causing the computer to execute:
processing for further acquiring settlement history information regarding a settlement history of the user in the facility; and
processing for controlling, in a case where the biometric authentication has been successful in one of the plurality of locations other than the first location, the guidance based on the preference information and the settlement history information of the user.

### REFERENCE SIGNS LIST

10, 300 Information Processing Apparatus
100 Authentication System
200 Authentication Terminal
11, 341 Preference Acquisition Unit (Preference Information Acquisition Means)
12, 342 Registration Unit (User Information Registration Means)
13 User Information Storage Unit (User Information Storage Means)
310 Storage Unit (User Information Storage Means)
14, 343 Authentication Unit (Authentication Means)
15, 345 Guidance control Unit (Guidance control Means)
344 History Update Unit (History Update Means)
261 Image Acquisition Unit (Authentication Biometric Information Acquisition Means)

What is claimed is:

1. An information processing apparatus comprising:
a memory storing instructions; and
one or more processors configured to execute the instructions to:
acquire preference information regarding preference of a user;
register biometric information for registration of the user in association with the preference information of the user in storage;
perform biometric authentication by comparing biometric information for authentication of the user acquired in each of a plurality of locations in a facility with the biometric information for registration; and
control, in a case where the biometric authentication has been successful, a guidance based on at least the preference information of the user.

2. The information processing apparatus according to claim 1, wherein the one or more processors controls, in a case where the biometric authentication has been successful in the first location among the plurality of locations, the guidance based on the preference information of the user.

3. The information processing apparatus according to claim 2, the one or more processors configured to execute the instructions to: acquire touring history information regarding a touring history of the user in the facility,
wherein the one or more processors controls, in a case where the biometric authentication has been successful in one of the plurality of locations other than the first location, the guidance based on the preference information and the touring history information of the user.

4. The information processing apparatus according to claim 2, the one or more processors configured to execute the instructions to: acquire settlement history information regarding a settlement history of the user in the facility,
wherein the one or more processors controls, in a case where the biometric authentication has been successful in one of the plurality of locations other than the first location, the guidance based on the preference information and the settlement history information of the user.

5-8. (canceled)

9. An authentication method, wherein a computer:
acquires preference information regarding preference of a user;
registers biometric information for registration in association with the preference information of the user in storage;
performs biometric authentication by comparing biometric information for authentication of the user acquired in each of a plurality of locations in a facility with the biometric information for registration; and
controls, in a case where the biometric authentication has been successful, a guidance based on at least the preference information of the user.

10. The authentication method according to claim 9, wherein the computer controls, in a case where the biometric authentication has been successful in the first location among the plurality of locations, the guidance based on the preference information of the user.

11. The authentication method according to claim 10, wherein the computer:
further acquires touring history information regarding a touring history of the user in the facility; and
controls, in a case where the biometric authentication has been successful in one of the plurality of locations other than the first location, the guidance based on the preference information and the touring history information of the user.

12. The authentication method according to claim 10, wherein the computer:
further acquires settlement history information regarding a settlement history of the user in the facility; and
controls, in a case where the biometric authentication has been successful in one of the plurality of locations other than the first location, the guidance based on the preference information and the settlement history information of the user.

13. A non-transitory computer readable medium storing a program for causing a computer to execute:
processing for acquiring preference information regarding preference of a user;
processing for registering biometric information for registration in association with the preference information of the user in storage;
processing for performing biometric authentication by comparing biometric information for authentication of the user acquired in each of a plurality of locations in a facility with the biometric information for registration; and
processing for controlling, in a case where the biometric authentication has been successful, a guidance based on at least the preference information of the user.

14. The non-transitory computer readable medium according to claim 13, the non-transitory computer readable medium storing a program for causing the computer to execute processing for controlling, in a case where the biometric authentication has been successful in the first location among the plurality of locations, the guidance based on the preference information of the user.

15. The non-transitory computer readable medium according to claim 14, the non-transitory computer readable medium storing a program for causing the computer to execute:
processing for further acquiring touring history information regarding a touring history of the user in the facility; and
processing for controlling, in a case where the biometric authentication has been successful in one of the plurality of locations other than the first location, the guidance based on the preference information and the touring history information of the user.

16. The non-transitory computer readable medium according to claim 14, the non-transitory computer readable medium storing a program for causing the computer to execute:
processing for further acquiring settlement history information regarding a settlement history of the user in the facility; and
processing for controlling, in a case where the biometric authentication has been successful in one of the plurality of locations other than the first location, the guidance based on the preference information and the settlement history information of the user.
